(19) United States
(12) Patent Application Publication
(10) Pub. No.: US 2025/0088123 A1
(43) Pub. Date: Mar. 13, 2025

(54) ELECTRIC GENERATOR

(71) Applicant: SEIKO EPSON CORPORATION, Tokyo (JP)

(72) Inventors: Yukio Yamauchi, Chino-shi (JP); Takeo Funakawa, Chino-shi (JP)

(21) Appl. No.: 18/826,637

(22) Filed: Sep. 6, 2024

(30) Foreign Application Priority Data
Sep. 7, 2023 (JP) 2023-145327

(51) Int. Cl. H02N 1/06

(52) U.S. Cl. CPC H02N 1/06

(57) ABSTRACT

An electric generator includes a shaft, a rotating plate including a silicon substrate having an insertion hole that receives the shaft, a first base facing the rotating plate, an electret film disposed on one of the rotating plate and the first base to face the other of the rotating plate and the first base, and a first electrode disposed on the other of the rotating plate and the first base to face the electret film. The shaft has at least one groove extending in an axial direction, and the rotating plate has first beams each extending from an outer periphery of the insertion hole to an interior of the insertion hole and having a tip in the at least one groove and a second beam located between the first beams and having a tip that presses the shaft.

The present application is based on, and claims priority from JP Application Serial Number 2023-145327, filed Sep. 7, 2023, the disclosure of which is hereby incorporated by reference herein in its entirety.

### BACKGROUND

### 1. Technical Field

The present disclosure relates to an electric generator.

### 2. Related Art

The electric generator described in JP-A-2015-192577 includes a first substrate, a plurality of electret electrodes on the first substrate, a second substrate facing the first substrate, a plurality of electrodes on the second substrate, and a rotation shaft coaxially connecting the first substrate and the second substrate. This type of electric generator uses relative rotation of the first and second substrates to generate electricity.

Such an electric generator can more efficiently generate electricity as a distance between the electret electrode and the electrode decreases, but the electret electrode and the electrode should not be in contact with each other. However, it is difficult to reduce the distance between the electret electrode and the electrode due to factors such as low flatness of the first substrate, ease of warping or flexing of the first substrate, and titling of the first and second substrates relative to the rotation shaft.

### SUMMARY

According to an aspect of the present disclosure, an electric generator includes: a shaft; a rotating plate including a silicon substrate having an insertion hole that receives the shaft; a first base facing the rotating plate; an electret film disposed on one of the rotating plate and the first base to face the other of the rotating plate and the first base; and a first electrode disposed on the other of the rotating plate and the first base to face the electret film, wherein the shaft has at least one groove extending in an axial direction, and the rotating plate has first beams each extending from an outer periphery of the insertion hole to an interior of the insertion hole and having a tip located in the at least one groove and a second beam located between the first beams and having a tip that presses the shaft.

### BRIEF DESCRIPTION OF THE DRAWINGS

FIG. 1 is a cross-sectional view illustrating an electric generator according to a first embodiment.

FIG. 2 is a perspective view of a shaft of the electric generator illustrated in FIG. 1.

FIG. 3 is a plan view of a rotating plate of the electric generator illustrated in FIG. 1.

FIG. 4 is a magnified plan view illustrating a holding portion of the rotating plate.

FIG. 5 is a magnified plan view illustrating the holding portion of the rotating plate.

FIG. 6 is a magnified cross-sectional view illustrating first and second spacers of the electric generator illustrated in FIG. 1.

FIG. 7 is a cross-sectional view illustrating an electric generator according to a second embodiment.

FIG. 8 is a perspective view of a shaft of the electric generator illustrated in FIG. 7.

### DESCRIPTION OF EMBODIMENTS

Hereinafter, an electric generator according to the present disclosure will be described in detail with reference to embodiments illustrated in the attached drawings.

### First Embodiment

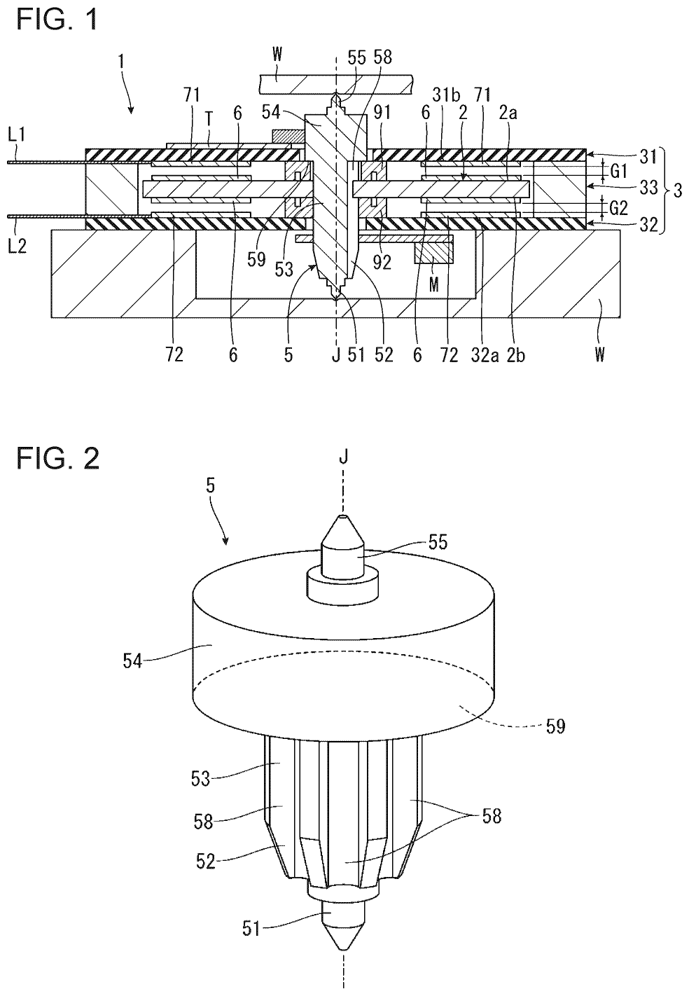

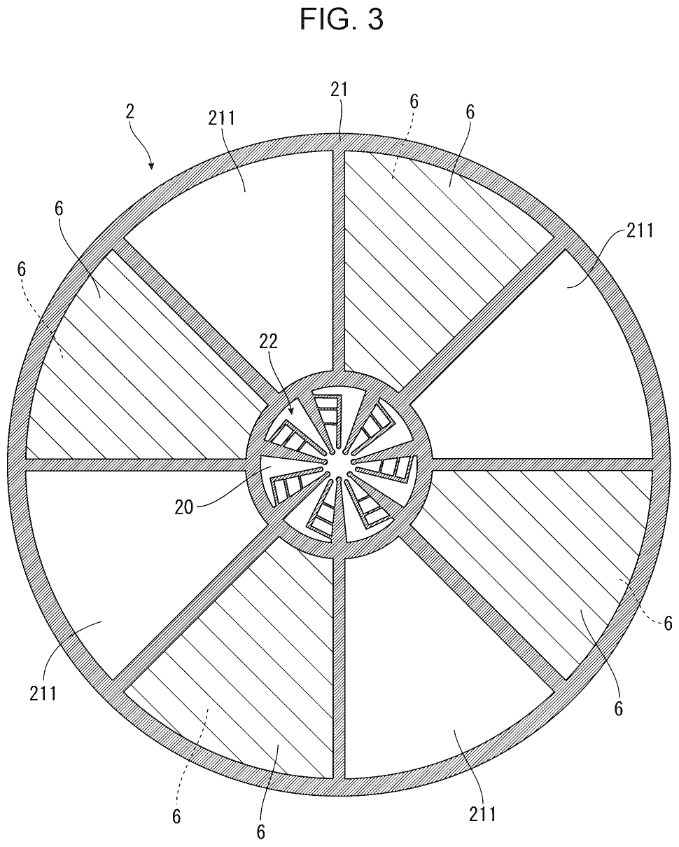

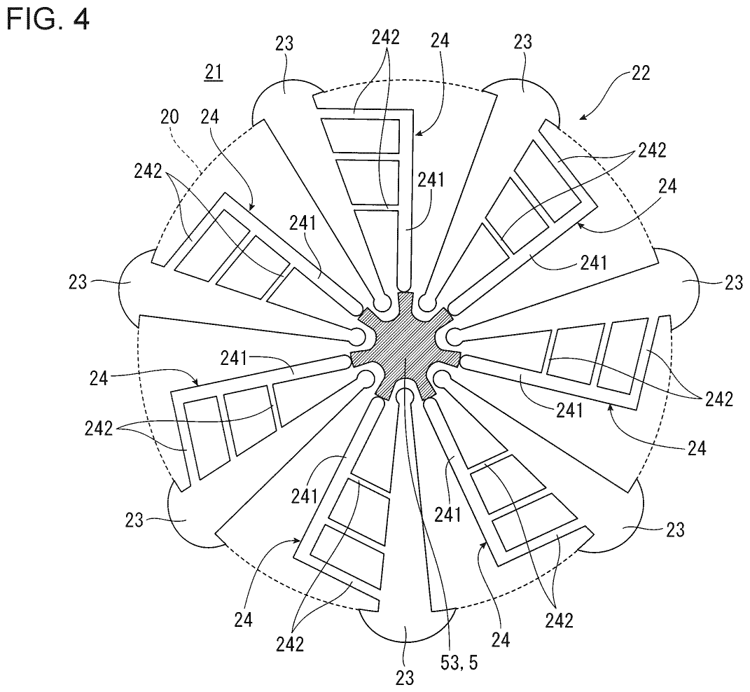

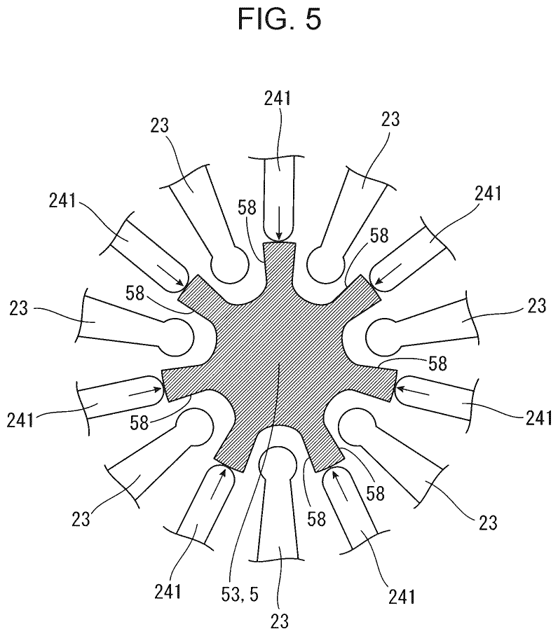

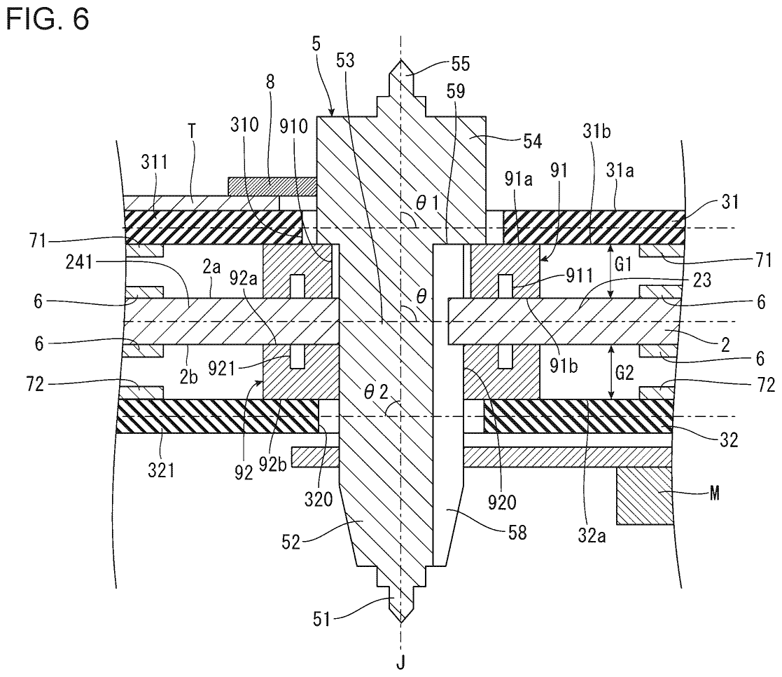

FIG. 1 is a cross-sectional view illustrating an electric generator according to a first embodiment. FIG. 2 is a perspective view of a shaft of the electric generator illustrated in FIG. 1. FIG. 3 is a plan view of a rotating plate of the electric generator illustrated in FIG. 1. FIGS. 4 and 5 are magnified plan views illustrating a holding portion of the rotating plate. FIG. 6 is a magnified cross-sectional view of first and second spacers of the electric generator illustrated in FIG. 1. Hereinafter, for convenience of explanation, the upper side and the lower side in FIG. 1 are also referred to as above and below, respectively.

The electric generator 1 illustrated in FIG. 1 includes a rotating plate 2, a first base 31 facing an upper surface 2a of the rotating plate 2 with a gap G1 therebetween, a second base 32 facing a lower surface 2b of the rotating plate 2 with a gap G2 therebetween, a side wall 33 connecting the first base 31 and the second base 32, a shaft 5 connected to the rotating plate 2, electret films 6 on the upper surface 2a and the lower surface 2b of the rotating plate 2, first electrodes 71 on a lower surface 31b of the first base 31, second electrodes 72 on an upper surface 32a of the second base 32, a first spacer 91 between the rotating plate 2 and the first base 31, and a second spacer 92 between the rotating plate 2 and the second base 32.

The electric generator 1, which has the first and second electrodes 71 and 72 located both above and below the rotating plate 2, can generate more electricity. However, the configuration of the electric generator 1 is not limited. For example, the second base 32 and the second electrodes 72 may be eliminated, and the electric generator 1 may only include the first base 31 and the first electrodes 71 located above the rotating plate 2. In this case, the electric generator 1 can generate less electricity than that in the first embodiment, but the electric generator 1 can be thinner.

### Shaft 5

As illustrated in FIG. 1, the shaft 5 is a columnar member extending in a straight line in the vertical direction. The shaft 5 has a first tenon 51, a guide 52, a first shaft portion 53, a second shaft portion 54, and a second tenon 55. The first tenon 51, the guide 52, the first shaft portion 53, the second shaft portion 54, and the second tenon 55 are arranged in the axial direction from the lower side in this order. These portions are integrally formed.

The shaft 5 is formed of carbon steel, which has high rigidity and high heat resistance and can be easily machined through, for example, cutting processing and grinding processing. However, the material of the shaft 5 is not limited, and materials other than carbon steel, such as tantalum (Ta) and tungsten (W) may be used.

As illustrated in FIG. 1, the first tenon 51 is a lower end portion of the shaft 5, and the second tenon 55 is an upper end portion of the shaft 5. The first and second tenons 51 and 55 each have a rod-like shape and serve as a pivot point of the shaft 5. The shaft 5 is supported on main plates W at the first and second tenons 51 and 55 in a rotatable manner around the central axis J.

As illustrated in FIGS. 1 and 2, the second shaft portion 54 has a larger diameter than the first shaft portion 53. In other words, the diameter of the second shaft portion 54 is larger than that of the first shaft portion 53. Thus, the first shaft portion 53 and the second shaft portion 54 form a seating surface 59 at the connection. The seating surface 59 is a surface perpendicular to the central axis J of the shaft 5. The “larger diameter” does not limit the first and second shaft portions 53 and 54 to a circular shape and can be applied to any case in which at least a portion of the outer diametrical shape of the second shaft portion 54 is larger than that of the first shaft portion 53.

As illustrated in FIG. 1, the first shaft portion 53 holds the first spacer 91, the rotating plate 2, and the second spacer 92. These components will be explained in detail later.

As illustrated in FIGS. 1 and 2, the guide 52 is located between the first shaft portion 53 and the first tenon 51. The guide 52 guides the first spacer 91, the rotating plate 2, and the second spacer 92 to the first shaft portion 53. The guide 52 has a tapered shape in which the diameter gradually decreases from the first shaft portion 53 to the first tenon 51. The outer diameter of the guide 52 at the end adjacent to the first shaft portion 53 is equal to that of the first shaft portion 53, and the outer diameter of the guide 52 at the end adjacent to the first tenon 51 is larger than that of the first tenon 51.

As illustrated in FIGS. 1 and 2, the shaft 5 has grooves 58 continuously extending along the first shaft portion 53 and the guide 52. The grooves 58 each extend in a straight line along the central axis J of the shaft 5. The grooves 58 each have a rounded arc-shaped bottom. In this embodiment, seven grooves 58 are arranged at equal angular intervals in the circumferential direction of the shaft 5. However, the number of grooves 58 is not limited.

The shaft 5 is formed of a conductive material, particularly a metallic material, such as copper and aluminum. The shaft 5, which has conductivity, can be used as a portion of a conductor that electrically draws out the electret film 6 to a terminal T located on the first base 31, which will be described later. This allows the electret film 6 to be readily electrically drawn out. Furthermore, the shaft 5 formed of a metallic material can have higher strength. However, the material of the shaft 5 is not limited and may be a conductive material other than a metallic material or an insulating material.

As illustrated in FIG. 1, a weight M is connected to the above-described shaft 5 to rotate the rotating plate 2 around the central axis J. The weight M is positioned eccentrically with respect to the central axis J. Thus, when the central axis J is tilted with respect to the vertical direction, the weight M moves downward in the vertical direction due to its own weight, rotating the shaft 5 around the central axis J.

### Rotating Plate 2

As illustrated in FIG. 3, the rotating plate 2 has a disc-like shape and has an overall uniform thickness. The rotating plate 2 is formed of a silicon substrate, particularly, a single-crystal silicon substrate. The rotating plate 2 formed of a silicon substrate has high flatness with less warpage and deflection. This enables the gaps G1 and G2 between the rotating plate 2 and the first and second bases 31 and 32 to be further smaller while reducing the possibility of contact between the rotating plate 2 and the first and second bases 31 and 32. This can improve the efficiency of electric power generation of the electric generator 1.

However, the rotating plate 2 only has to contain a silicon substrate and may be formed of, for example, a composite substrate that includes another substrate or layer on this silicon substrate. A typical example thereof is a silicon on insulator (SOI) substrate.

As illustrated in FIG. 3, the rotating plate 2 has an insertion hole 20 that receives the shaft 5 in the middle and a rim portion 21 around the insertion hole 20. The rim portion 21 has four through holes 211 arranged in the circumferential direction. However, the number of through holes 211 is not limited. In FIG. 3, which is a plan view, for convenience of explanation, the rotating plate 2 and the electret film 6 are colored by hatching.

The rotating plate 2 has a holding portion 22 located in the middle and protruding in the insertion hole 20. When the holding portion 22 engages with the shaft 5, the rotating plate 2 is fixed to the shaft 5. The rim portion 21 and the holding portion 22 are integrally formed of a silicon substrate patterned by etching.

As illustrated in FIG. 4, the holding portion 22 has first beams 23 arranged radially and second beams 24 arranged radially. The first beams 23 protrude from the rim portion 21 to an interior of the insertion hole 20. The adjacent first beams 23 have one second beam 24 therebetween. Specifically, the second beams 24 each branch and protrude from the middle of the first beam 23 in an L-shape. In this embodiment, seven first beams 23, which is the same in number as the groove 58, are arranged at equal angular intervals in the circumferential direction of the rim portion 21, and one second beam 24 protrudes from each of the first beams 23, i.e., a total of seven second beams 24.

However, the number of each of first and second beams 23 and 24 is not limited and may be six or less or eight or more. The number of first beams 23 may differ from the number of second beams 24. In other words, at least one of the first beams 23 may have no branching second beam 24, or at least one of the first beams 23 may have multiple branching second beams 24.

The first beams 23 each extend in a straight line toward the shaft 5 in the radial direction of the rotating plate 2. The first beams 23 each have a tapered shape in which the width decreases toward the tip and a rounded tip having a slightly larger width and a circular shape. The diameter of a circle inscribed in a shape defined by the tips of these seven first beams 23 is smaller than the outer diameter of the first shaft portion 53.

The second beams 24 each have a pressing portion 241 and multiple spring portions 242 connecting the pressing portion 241 and the first beam 23. The pressing portion 241 extends in a straight line in the radial direction of the rotating plate 2 toward the shaft 5 and has a rounded tip having a circular shape. The diameter of the circle inscribed in a shape defined by the tips of these seven pressing portions 241 is slightly smaller than the outer diameter of the first shaft portion 53. The base of the pressing portion 241 is connected to the first beam 23 through the spring portions 242. The spring portions 242 are arranged in the radial direction of the rotating plate 2 and generally extend in a straight in the circumferential direction of the rotating plate 2. Each spring portion 242 is a leaf spring, which biases the pressing portion 241 toward the shaft 5 when elastically deformed in the radial direction of the rotating plate 2.

As illustrated in FIG. 5, when the shaft 5 is inserted, the tips of the first beams 23 are in the corresponding grooves 58 of the first shaft portion 53. The groove 58 is recessed deeper in a direction away from the first beam 23, and thus the tip of the first beam 23 is unlikely to come in contact with the groove 58, and the first beam 23 is unlikely to receive excessive stress. In contrast, the pressing portions 241 each have a tip in contact with the outer circumferential surface of the first shaft portion 53. Here, as described above, the diameter of the circle inscribed in a shape defined by the tips of the seven pressing portions 241 is slightly smaller than the outer diameter of the first shaft portion 53. Thus, when the first shaft portion 53 is inserted in the insertion hole 20, the spring portion 242 of each second beam 24 is elastically deformed and its restoring force biases the pressing portion 241 toward the tip. Then, the biased pressing portion 241 presses the first shaft portion 53. In this way, the rotating plate 2 is connected to the shaft 5.

The seven second beams 24 uniformly press the outer surface of the first shaft portion 53, and thus the rotating plate 2 is held concentrically with the shaft 5 in a stable posture. Although the rotating plate 2 formed of a silicon substrate is brittle and easy to damage, the pressing force is dispersed to the seven second beams 24, effectively reducing damage to the holding portion 22.

### Electret Film 6

As illustrated in FIG. 3, multiple electret films 6 are symmetrically arranged on each of the upper and lower surfaces of the rim portion 21 of the rotating plate 2. Specifically, the electret film 6 is located between adjacent two through holes 211 so that the through holes 211 and the electret films 6 are alternately arranged.

The electret film 6 is a negatively charged film. The configuration of the electret film 6 is not limited. For example, the electret film 6 may be formed by electrically charging a silicon oxide film formed by thermal oxidation of the surface of the rotating plate 2. Alternatively, for example, the electret film 6 may be formed by electrically charging a silicon oxide film deposited on a surface of the rotating plate 2 by using a vapor deposition method, such as plasma CVD. These techniques, which take advantages of the characteristics of the silicon substrate to form the electret film 6, make formation of the electret film 6 easy.

In this embodiment, the electret films 6 are disposed on the upper and lower surfaces of the rim portions 21, and thus warping and deflection of the rotating plate 2 are effectively reduced, effectively reducing a decrease in flatness of the rotating plate 2. This can make the gaps G1 and G2 between the rotating plate 2 and the first and second bases 31 and 32 smaller while preventing contact between the rotating plate 2 and the first and second bases 31 and 32, improving the efficiency of electric power generation of the electric generator 1.

### First Spacer 91

As illustrated in FIG. 6, the first spacer 91 is located between the rotating plate 2 and the first base 31. The first spacer 91 controls the gap G1 between the rotating plate 2 and the first base 31. The first spacer 91 has a cylindrical tubular shape and has an insertion hole 910 that receives the shaft 5 in the middle. The first spacer 91 has a larger diameter than the second shaft portion 54. In other words, the outer diameter of the first spacer 91 is larger than that of the second shaft portion 54. The “larger diameter” is not intended to limit the first spacer 91 to a circular shape, and the first spacer 91 can have any shape in which at least a portion of the outer diametrical shape is larger than that of the second shaft portion 54.

The insertion hole 910 has a larger diameter than the first shaft portion 53 and has a smaller diameter than the second shaft portion 54. Thus, when the shaft 5 is inserted into the insertion hole 910 from the first tenon 51, the seating surface 59 comes in contact with an upper surface 91a of the first spacer 91, preventing further insertion of the shaft 5. This positions the first spacer 91 relative to the shaft 5. The lower surface 91b of the first spacer 91 has an annular recess 911 surrounding the insertion hole 910. The first spacer 91 is in contact with the upper surface 2a of the rotating plate 2, more specifically the upper surface of the holding portion 22, at the portions of the lower surface 91b located radially inward and outward from the recess 911.

The first spacer 91 may be formed of any material. Examples of the material include copper, copper alloys, aluminum, aluminum alloys, iron alloys, and titanium alloys. Among these materials, iron alloys and titanium alloys are preferred. The first spacer 91 formed of such a material can have high hardness and high deformation resistance.

### Second Spacer 92

As illustrated in FIG. 6, the second spacer 92 is located between the rotating plate 2 and the second base 32. The second spacer 92 controls the gap G2 between the rotating plate 2 and the second base 32 and fixes the rotating plate 2 to the shaft 5. The second spacer 92 has a cylindrical tubular shape and has an insertion hole 920 that receives the shaft 5 in the middle. The second spacer 92 has a larger diameter than the second shaft portion 54, and the outer diameter is substantially equal to that of the first spacer 91. The “larger diameter” is not intended to limit the second spacer 92 to a circular shape, and the second spacer 92 can have any shape in which at least a portion of the outer diametrical shape is larger than that of the second shaft portion 54.

The insertion hole 920 has a slightly smaller diameter than the first shaft portion 53. Thus, the second spacer 92 is tightly fit to the first shaft portion 53. An upper surface 92a of the second spacer 92 has an annular recess 921 surrounding the insertion hole 920. The second spacer 92 is in contact with the lower surface 2b of the rotating plate 2, more specifically the lower surface of the holding portion 22, at the portions of the upper surface 92a located radially inward and outward from the recess 921.

When the second spacer 92 presses the lower surface of the rotating plate 2 toward the first spacer 91, the rotating plate 2 is sandwiched between the first spacer 91 and the second spacer 92. This firmly fixes the rotating plate 2 to the shaft 5. As described above, the first and second spacers 91 and 92 have a larger outer diameter than the second shaft portion 54, and thus the rotating plate 2 can be held at a position further away from the central axis J of the shaft 5. Thus, the inclination θ of the rotating plate 2 with respect to the central axis J of the shaft 5 can be close to the right angle. The closer the inclination θ is to the right angle, displacement of the rotating plate 2 in the axial direction caused by rotation of the shaft 5 decreases. This can make the gaps G1 and G2 between the rotating plate 2 and the first and second bases 31 and 32 further smaller while reducing the possibility of contact between the rotating plate 2 and the first and second bases 31 and 32, improving the efficiency of electric power generation of the electric generator 1.

In particular, as described above, due to the presence of the recess 911 in the lower surface 91b of the first spacer 91, a portion of the lower surface 91b of the first spacer 91 that is closer to the outer edge, i.e., a portion located radially outward from the recess 911, can be in contact with the upper surface 2a of the rotating plate 2 more reliably without influence of flatness of the lower surface 91b. Similarly, due to the presence of the recess 921 in the upper surface 92a of the second spacer 92, a portion of the upper surface 92a of the second spacer 92 that is closer to the outer edge, i.e., a portion located radially outward from the recess 921, can be in contact with the lower surface 2b of the rotating plate 2 more reliably without influence of flatness of the upper surface 92a. This makes the above-described effect more prominent. Furthermore, the second spacer 92 is fixed to the first shaft portion 53 by tight fitting, and thus the second spacer 92 can be fixed to the first shaft portion 53 without an additional component such as an adhesive. Thus, a foreign substance is unlikely to exist between the rotating plate 2 and the first and second spacers 91 and 92, making the above-described effect more prominent.

Furthermore, as described above, the holding portion 22 of the rotating plate 2 is sandwiched between the first spacer 91 and the second spacer 92, and thus the holding portion 22 is reinforced from both the upper and lower sides by the first and second spacers 91 and 92. This improves the mechanical strength of the holding portion 22, effectively reducing damage to the holding portion 22. Thus, the mechanical strength of the electric generator 1 can be effectively increased.

The second spacer 92 may be formed of any material. Examples of the material include copper, copper alloys, aluminum, aluminum alloys, iron alloys, and titanium alloys. Among these materials, copper, copper alloys, aluminum, and aluminum alloys are preferred. The second spacer 92 formed of such a material can have sufficiently high strength and high deformability, allowing the second spacer 92 to be readily fixed by tight fitting.

The configuration of the second spacer 92 is not limited. For example, the second spacer 92 may be a C-shaped snap ring, instead of the cylindrical tubular spacer. The second spacer 92 having such a configuration also can be fixed to the first shaft portion 53 without an adhesive.

### First Base 31

As illustrated in FIG. 6, the first base 31 faces the upper surface of the rotating plate 2 with the gap G1 therebetween. The first base 31 supports the first electrodes 71.

The first base 31 is a disc-shaped plate and has a uniform overall thickness. The first base 31 is formed of an insulating material, such as a resin material, a glass material, and a ceramic material. This readily enables the first electrodes 71 supported on the first base 31 to be insulated from the shaft 5. Thus, a short circuit between the first electrode 71 and the electret film 6 is reduced. However, the material of the first base 31 is not limited.

The first base 31 has an insertion hole 310 that receives the shaft 5 in the middle and a rim portion 311 around the insertion hole 310. On the lower surface of the rim portion 311, i.e., the surface adjacent to the rotating plate 2, the first electrodes 71, which are the same in number and shape as the electret films 6, are arranged in the circumferential direction. As illustrated in FIG. 1, the first electrodes 71 are drawn out to the outside of the electric generator 1 by wiring L1.

As illustrated in FIG. 6, the lower surface 31b of the first base 31 is in contact with the upper surface 91a of the first spacer 91. Thus, there is no space and additional components between the first base 31 and the first spacer 91, enabling easy and accurate control of the gap G1. Furthermore, this makes the posture of the first base 31 stable, and thus the inclination θ1 of the first base 31 with respect to the central axis J of the shaft 5 can be close to the right angle. This can make the gap G1 between the first base 31 and the rotating plate 2 smaller as the inclination θ1 is closer to the right angle while reducing the possibility of contact between the first base 31 and the rotating plate 2, improving the efficiency of electric power generation of the electric generator 1.

The first spacer 91, which is fixed to the shaft 5 through the second spacer 92, slides against the lower surface 31b of the first base 31 as the shaft 5 rotates. In view of this, it is preferable that at least one of the upper surface 91a of the first spacer 91 and the lower surface 31b of the first base 31 be subjected to a process that reduces frictional resistance to improve slidability, such as a fluorine resin coating. This enables the rotating plate 2 to rotate with less torque.

The terminal T is located on the upper surface 31a of the first base 31. This terminal T is connected to the shaft 5 via a contact member 8 such as a brush. This electrically connects the terminal T to the electret film 6. The shaft 5 formed of a conductive material makes this configuration possible, and thus the electret film 6 can be readily electrically drawn out.

### Second Base 32

As illustrated in FIG. 6, the second base 32 faces the lower surface of the rotating plate 2 with the gap G2 therebetween. In other words, the rotating plate 2 is located between the second base 32 and the first base 31. The second base 32 supports the second electrodes 72. The electric generator 1 is mounted on a target when the second base 32 is fixed to the main plate W.

The second base 32 has a similar configuration as the first base 31. In other words, the second base 32 is a disc-shaped plate and has a uniform overall thickness. The second base 32 is formed of an insulating material, such as a resin material, a glass material, and a ceramic material. This readily enables the second electrodes 72 supported on the second base 32 to be insulated from the shaft 5. Thus, a short circuit between the second electrode 72 and the electret film 6 is reduced. However, the material of the second base 32 is not limited.

The second base 32 has an insertion hole 320 that receives the shaft 5 in the middle and a rim portion 321 around the insertion hole 320. On the upper surface of the rim portion 321, i.e., the surface adjacent to the rotating plate 2, the second electrodes 72, which are the same in number and shape as the electret films 6, are arranged in the circumferential direction. As illustrated in FIG. 1, the second electrodes 72 are drawn out to the outside of the electric generator 1 by wiring L2.

As illustrated in FIG. 6, the upper surface 32a of the second base 32 is in contact with the lower surface 92b of the second spacer 92. Thus, there is no space and additional components between the second base 32 and the second spacer 92, enabling easy and accurate control of the gap G2. Furthermore, this makes the posture of the second base 32 stable, and thus the inclination θ2 of the second base 32 with respect to the central axis J of the shaft 5 can be close to the right angle. This can make the gap G2 between the second base 32 and the rotating plate 2 smaller as the inclination θ2 is closer to the right angle while reducing the possibility of contact between the second base 32 and the rotating plate 2, improving the efficiency of electric power generation of the electric generator 1.

The second spacer 92, which is fixed to the shaft 5, slides against the upper surface 32a of the second base 32 as the shaft 5 rotates. In view of this, it is preferable that at least one of the lower surface 92b of the second spacer 92 and the upper surface 32a of the second base 32 be subjected to a process that reduces frictional resistance to improve slidability, such as a fluorine resin coating. This enables the rotating plate 2 to rotate with less torque.

### Side Wall 33

As illustrated in FIG. 1, the side wall 33 has a cylindrical tubular shape and surrounds the rotating plate 2. The side wall 33 has an upper end in contact with the first base 31 and a lower end in contact with the second base 32. Thus, the first base 31 and the second base 32 are positionally fixed by the side wall 33, reducing relative displacement between them. The first base 31, the second base 32, and the side wall 33 integrally constitute a package 3 that houses the rotating plate 2, which can protect the rotating plate 2.

The electric generator 1 is described above. As described above, the electric generator 1 includes the shaft 5, the rotating plate 2 including a silicon substrate having the insertion hole 20 that receives the shaft 5, the first base 31 that faces the rotating plate 2, the electret film 6 disposed on one of the rotating plate 2 and the first base 31 to face the other of the rotating plate 2 and the first base 31, and the first electrode 71 disposed on the other of the rotating plate 2 and the first base 31 to face the electret film 6. The shaft 5 has the grooves 58 extending in the axial direction. The rotating plate 2 has the first beams 23 each extending from an outer periphery of the insertion hole 20 to an interior of the insertion hole 20 and having a tip in the groove 58 and the second beams 24 located between the first beams 23 and each having a tip that presses the shaft 5. Although the rotating plate 2 including a silicon substrate is brittle and easily damaged, the pressing force is dispersed to the multiple second beams 24, effectively reducing damage to the holding portion 22. Thus, the rotating plate 2 can be formed of a silicon substrate. The rotating plate 2 formed of a silicon substrate has high flatness with less warpage and deflection. This can make the gap G1 between the first base 31 and the rotating plate 2 further smaller while reducing the possibility of contact between the first base 31 and the rotating plate 2, improving the efficiency of electric power generation of the electric generator 1.

Furthermore, as described above, the electric generator 1 includes the first spacer 91 in which the shaft 5 is inserted and that is located between the rotating plate 2 and the first base 31. This makes control of the gap G1 between the rotating plate 2 and the first base 31 easy.

Furthermore, as described above, the first spacer 91 has a larger diameter than the shaft 5, and the lower surface 91b of the first spacer 91 that is adjacent to the rotating plate 2 is in contact with the rotating plate 2. This configuration enables the rotating plate 2 to be held at a position further away from the central axis J of the shaft 5. Thus, the inclination θ of the rotating plate 2 with respect to the central axis J of the shaft 5 can be close to the right angle. The closer the inclination θ is to the right angle, displacement of the rotating plate 2 caused by rotation of the shaft 5 decreases. This can make the gap G1 between the first base 31 and the rotating plate 2 further smaller while reducing the possibility of contact between the first base 31 and the rotating plate 2, improving the efficiency of electric power generation of the electric generator 1.

Furthermore, as described above, the shaft 5 includes the first shaft portion 53, the second shaft portion 54 having a larger diameter than the first shaft portion 53, the seating surface 59 between the first shaft portion 53 and the second shaft portion 54. The first shaft portion 53 is inserted in the first spacer 91. The first spacer 91 is in contact with the seating surface 59. The electric generator 1 further includes the second spacer 92 fixed to the first shaft portion 53 and sandwiching the rotating plate 2 with the first spacer 91. With this simple configuration, the rotating plate 2 can be fixed to the shaft 5 with the lower surface 91b of the first spacer 91 being in contact with the rotating plate 2.

Furthermore, as described above, the electret films 6 are disposed on the rotating plate 2, and the first electrodes 71 are disposed on the first base 31. This configuration, which takes advantages of the characteristics of the silicon substrate to form the electret films 6, makes formation of the electret films 6 easy.

Furthermore, as described above, the electric generator 1 includes the second base 32 facing the rotating plate 2 and located on the opposite side of the rotating plate 2 from the first base 31, and the second electrode 72 located on the second base 32 and facing the rotating plate 2. The electret films 6 are located on both surfaces of the rotating plate 2 to face the first and second electrodes 71 and 72. This enables the electric generator 1 to generate more electricity.

Furthermore, as described above, the electric generator 1 has the second spacer 92 in which the shaft 5 is inserted and that is located between the rotating plate 2 and the second base 32. This makes control of the gap G2 between the rotating plate 2 and the second base 32 easy. Furthermore, as described above, the second spacer 92 has a larger diameter than the shaft 5, and the upper surface 92a of the second spacer 92 that is adjacent to the rotating plate 2 is in contact with the rotating plate 2. This configuration enables the rotating plate 2 to be held at a position further away from the central axis J of the shaft 5. Thus, the inclination θ of the rotating plate 2 with respect to the central axis J of the shaft 5 can be close to the right angle. The closer the inclination θ is to the right angle, displacement of the rotating plate 2 caused by rotation of the shaft 5 decreases. This can make the gap G2 between the second base 32 and the rotating plate 2 further smaller while reducing the possibility of contact between the second base 32 and the rotating plate 2, improving the efficiency of electric power generation of the electric generator 1.

Furthermore, as described above, the shaft 5 has conductivity. Thus, the electret film 6 can be readily electrically drawn out.

### Second Embodiment

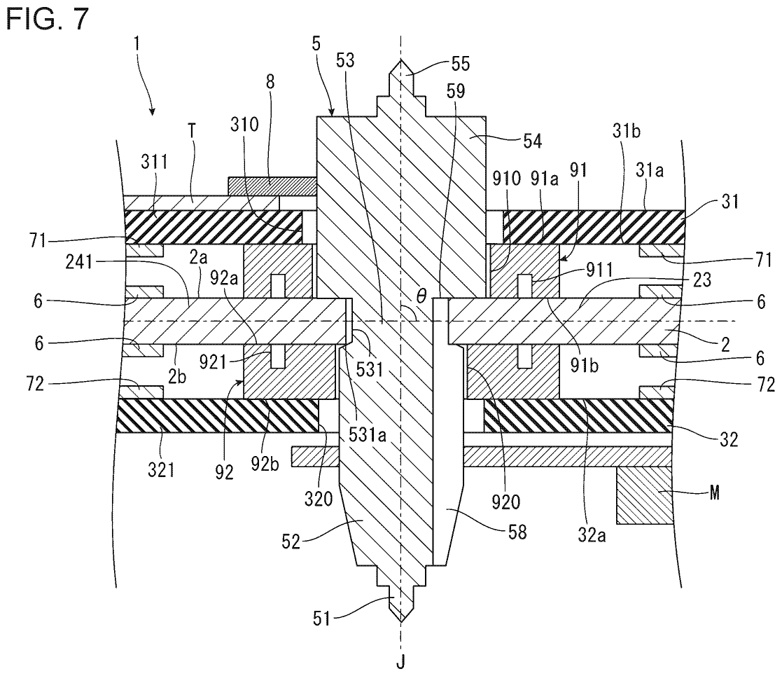

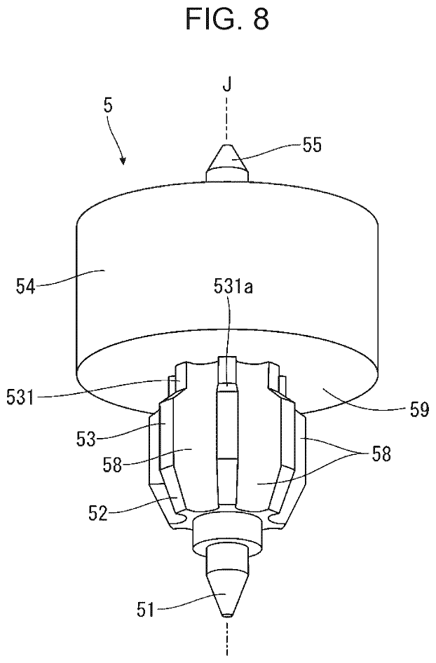

FIG. 7 is a cross-sectional view illustrating an electric generator according to a second embodiment. FIG. 8 is a perspective view of a shaft of the electric generator illustrated in FIG. 7.

This embodiment is the same as the above-described first embodiment except for the configuration of the shaft. The following description will focus on the differences of this embodiment from the above-described first embodiment, and configurations similar to those of the first embodiment will not be described. In the drawings of this embodiment, components similar to those in the first embodiment are assigned the same reference numerals as those in the first embodiment.

As illustrated in FIGS. 7 and 8, the shaft 5 of this embodiment has a recess 531 in the first shaft portion 53. The recess 531 is located at the upper end of the first shaft portion 53 and has an annular shape extending in the circumferential direction. Since the depth of the recess 531 is smaller than that of the groove 58, the first shaft portion 53 has the outer shape in which the recesses 531 and the grooves 58 are alternately arranged in the circumferential direction. The tip of the second beam 24 of the rotating plate 2 fits in this recess 531. As in the above-described first embodiment, in the fitted state, the spring portion 242 is elastically deformed, and the restoring force makes the pressing portion 241 press the first shaft portion 53. Thus, the rotating plate 2 is fixed to the shaft 5.

The recess 531 has a tapered portion 531a having a downward sloping surface at its lower end. The tip portion of the pressing portion 241 is in contact with the tapered portion 531a. Thus, the biasing force of the spring portion 242 is divided into a force of the pressing portion 241 pressing the shaft 5 and a force pressing the rotating plate 2 upward, and the rotating plate 2 is pressed against the seating surface 59. This allows the upper surface 2a of the rotating plate 2 to come in strong contact with the seating surface 59, and the inclination θ of the rotating plate 2 with respect to the central axis J of the shaft 5 can be close to the right angle.

The second shaft portion 54 of the shaft 5 is inserted into the first spacer 91. The first spacer 91 has an insertion hole 910 having a diameter larger than the outer diameter of the second shaft portion 54 and is not fixed to the shaft 5. The first spacer 91 is only in contact with the rotating plate 2 and the first base 31 and is not fixed to them. Thus, the first spacer 91 slides on at least one of the rotating plate 2 and the first base 31 when the rotating plate 2 rotates.

The first shaft portion 53 of the shaft 5 is inserted into the second spacer 92. The second spacer 92 has an insertion hole 920 having a diameter larger than the outer diameter of the first shaft portion 53 and is not fixed to the shaft 5. Furthermore, the second spacer 92 is only in contact with the rotating plate 2 and the second base 32 and not fixed to them. Thus, the second spacer 92 slides on at least one of the rotating plate 2 and the second base 32 when the rotating plate 2 rotates.

However, this should not be construed as limiting, and for example, the first spacer 91 may be fixed to at least one of the shaft 5 and the rotating plate 2, or may be fixed to the first base 31. Similarly, the second spacer 92 may be fixed to at least one of the shaft 5 and the rotating plate 2, or may be fixed to the second base 32.

The second embodiment can also have the similar effects as the above-described first embodiment.

The electric generator according to the present disclosure was described above by using the embodiments illustrated in the drawings. However, the disclosure should not be limited to this, and the configuration of each component may be replaced with any configuration having similar functions. Furthermore, the present disclosure may include any one or more other additional components.

What is claimed is:

1. An electric generator comprising:
a shaft;
a rotating plate including a silicon substrate having an insertion hole that receives the shaft;
a first base facing the rotating plate;
an electret film disposed on one of the rotating plate and the first base to face the other of the rotating plate and the first base; and
a first electrode disposed on the other of the rotating plate and the first base to face the electret film, wherein
the shaft has at least one groove extending in an axial direction, and
the rotating plate has first beams each extending from an outer periphery of the insertion hole to an interior of the insertion hole and having a tip located in the at least one groove and a second beam located between the first beams and having a tip that presses the shaft.

2. The electric generator according to claim 1, further comprising a first spacer into which the shaft is inserted and located between the rotating plate and the first base.

3. The electric generator according to claim 2, wherein the first spacer has a larger diameter than the shaft, and
a surface of the first spacer that is adjacent to the rotating plate is in contact with the rotating plate.

4. The electric generator according to claim 2, wherein the shaft includes a first shaft portion, a second shaft portion having a larger diameter than the first shaft portion, and a seating surface between the first shaft portion and the second shaft portion,
the first shaft portion is in the first spacer,
the first spacer is in contact with the seating surface, and
the electric generator further comprises a second spacer fixed to the first shaft portion and sandwiching the rotating plate with the first spacer.

5. The electric generator according to claim 1, wherein the electret film is located on the rotating plate, and
the first electrode is located on the first base.

6. The electric generator according to claim 5, further comprising:
a second base facing the rotating plate and located on an opposite side of the rotating plate from the first base; and
a second electrode located on the second base and facing the rotating plate, wherein
the electret film is located on both surfaces of the rotating plate to face each of the first electrode and the second electrode.

7. The electric generator according to claim 6, further comprising a second spacer into which the shaft is inserted and located between the rotating plate and the second base.

8. The electric generator according to claim 7, wherein the second spacer has a larger diameter than the shaft, and
a surface of the second spacer that is adjacent to the rotating plate is in contact with the rotating plate.

9. The electric generator according to claim 1, wherein the shaft has conductivity.
